(19) United States
(12) Patent Application Publication
(10) Pub. No.: US 2012/0314191 A1
(43) Pub. Date: Dec. 13, 2012

(54) PROJECTOR AND IMAGE PROJECTION METHOD

(75) Inventor: Toshiki Fujimori, Shimosuwa-machi (JP)

(73) Assignee: Seiko Epson Corporation, Tokyo (JP)

(21) Appl. No.: 13/490,152

(22) Filed: Jun. 6, 2012

(30) Foreign Application Priority Data
Jun. 13, 2011 (JP) 2011-130986

(51) Int. Cl. G03B 21/14

(52) U.S. Cl. 353/70; 353/121

(57) ABSTRACT

A projector used with an external device having a tilt detection function and configured so that the external device can be connected to a projector main body at a predetermined installation angle projects an image on which a correction has been performed using a first tilt angle of the external device detected by the external device and the installation angle.

The entire disclosure of Japanese Patent Application No. 2011-130986, filed Jun. 13, 2011 is expressly incorporated by reference herein.

### BACKGROUND

1. Technical Field

The present invention relates to a projector, an image projection method and the like, and in particular to a projector, an image projection method and the like for performing shape correction of an image.

2. Related Art

In the past, the projector as a display device has been used in a variety of situations such as a meeting in the office or viewing of films in the home. Such a projector has high flexibility of installation, and the keystone distortion occurs in accordance with the angle formed between the optical axis (the projection light axis) of the projection light and the screen surface (the projection surface) depending on the installation conditions of the projector. Therefore, the projector is arranged to be able to perform the keystone correction for correcting the keystone distortion due to an image processing technology to thereby project the image on which the keystone correction has been performed on the projection surface.

A variety of propositions have been made regarding such a projector performing the keystone correction. For example, JP-A-2006-295292 (Document 1) discloses a technology of arranging that an imaging section is incorporated in the projector, and thus detecting a luminance peak from the shot image obtained by the imaging section shooting the screen surface to thereby detect the tilt of the screen surface. Further, for example, JP-A-2006-60447 (Document 2) discloses a technology of shooting the screen surface by the imaging section incorporated in the projector, and then interpolating an undetected side based on the shot image even if three or less sides constituting the screen frame can only be detected to thereby perform the keystone correction.

Meanwhile, in recent years, development of highly functional portable devices such as cellular phones has been progressed, and some of such devices incorporate an imaging section having an equivalent function to that of the imaging device provided to the projector described above. Moreover, as the portable devices of this kind, there have been proposed those provided with an image projection function similar to that of the projector described above in addition to the imaging section. In, for example, JP-A-2010-102064 (Document 3), there is proposed a cellular phone provided with an equivalent function to that of the projector, and further incorporating a gyro sensor inside the main body. In this cellular phone, the vibration is detected by the gyro sensor to thereby perform a correction with an opposite phase so as not to cause blurring due to the vibration of the main body in the projection image.

However, according to the technologies disclosed in Documents 1 through 3, the projector or the like is required to be provided with the imaging section or the gyro sensor. Therefore, growth in size of the projector and an analytical circuit of the shot image becomes necessary, and there arises a problem of incurring rise in cost of the projector, and hindering the cost reduction of the projector.

### SUMMARY

An advantage of some aspects of the invention is to provide a projector, an image projection method, and so on achieving downsizing and cost reduction as well as performing the shape correction of the image.

An aspect of the invention is directed to a projector used with an external device having a tilt detection function and configured so that the external device can be connected to a projector main body at a predetermined installation angle, and including an image correction section adapted to perform a shape correction of an image using a first tilt angle of the external device detected by the external device and the installation angle, and a projection section adapted to project an image on which the shape correction has been performed by the image correction section.

According to this aspect, the projector is configured so that the external device having the tilt detection function can be connected at a predetermined installation angle, and the shape correction of the image is performed using the tilt angle of the external device detected by the external device and the installation angle. By adopting such a configuration, it becomes possible to achieve downsizing and cost reduction of the projector capable of performing the shape correction of the image without providing the tilt detection function. Further, it becomes unnecessary to provide the image analysis circuit to the projector, and it becomes possible to achieve further cost reduction of the projector. Further, it becomes possible to improve the accuracy of the shape correction of the image due to a variety of performances of the external device such as the tilt detection function without being limited to the variety of performances provided to the projector such as the tilt detection function.

It is possible to easily calculate the tilt angle of the projector using the first tilt angle detected using the tilt detection function provided to the external device to thereby perform the shape correction of the image in accordance with the tilt angle of the projector. Thus, it becomes possible to provide a projector capable of the shape correction of the image corresponding to the tilt angle without providing the tilt detection function to the projector side.

It is possible to provide a projector capable of the shape correction of the image using the first tilt angle and so on detected using the tilt detection function of the external device without continuously connecting the projector and the external device to each other.

It is possible to calculate the correction parameter for performing the shape correction of the image, and then perform the shape correction process based on the correction parameter every time the first tilt angle changes. Thus, it becomes possible to realize the shape correction process of the image surely reflecting the projection condition and without performing an unnecessary calculation process.

### BRIEF DESCRIPTION OF THE DRAWINGS

The invention will be described with reference to the accompanying drawings, wherein like numbers reference like elements.

FIG. 1 is a diagram showing an overall configuration of a projector system according to an embodiment of the invention.

FIG. 2 is a functional block diagram of a configuration example of a projector and a portable device constituting the projector system according to the present embodiment.

FIG. 3 is a flowchart of a processing example of the portable device according to the present embodiment.

FIG. 4 is a flowchart of a processing example of the projector according to the present embodiment.

FIG. 5 is an explanatory diagram of a tilt angle of the projector.

### DESCRIPTION OF AN EXEMPLARY EMBODIMENT

Hereinafter, an embodiment of the invention will be described in detail with reference to the accompanying drawings. It should be noted that the embodiment described below does not unreasonably limit the content of the invention as set forth in the appended claims. Further, it is not necessarily true that all of the constituents described below are essential elements for solving the problem of the invention.

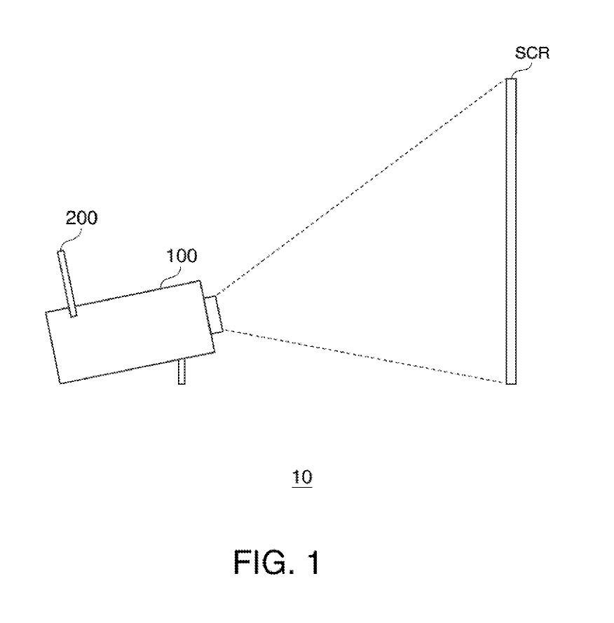

FIG. 1 shows an overall configuration of a projector according to an embodiment of the invention. FIG. 1 shows a side view of the projector.

The projector system (a display system in a broad sense) 10 is provided with a projector (a display device in a broad sense) 100 and a portable device (an external device in abroad sense) 200. The projector 100 is configured so that the portable device 200 having a tilt detection function can be connected to the projector main body at a predetermined installation angle. Specifically, the projector 100 is configured so that the portable device 200 can be installed at a predetermined installation angle with the projector main body, and connection terminals of the projector 100 and connection terminal of the portable device 200 are connected to each other in the state in which the portable device 200 is installed. When the connection terminals of the projector 100 and the connection terminals of the portable device 200 are connected to each other, it is possible for the projector 100 to take a variety of information obtained in the portable device 200 into the projector 100 and to control the portable device 200 in accordance with a predetermined protocol.

The portable device 200 is provided with a tilt detection sensor, and a tilt detection function realized by using the tilt detection sensor, and is thus capable of detecting the tilt angle of the portable device 200. Such a function of the portable device 200 is realized by a cellular phone, a portable information terminal, a portable music player, and so on.

The projector 100 performs the keystone correction (a shape correction in a broad sense) of the image using the tilt angle of the portable device 200 installed in the main body at a predetermined installation angle detected by the portable device 200, and then projects the image, on which the keystone correction has been performed, on a screen SCR. Specifically, the portable device 200 detects the tilt angle of itself, and then outputs the tilt angle or the information corresponding to the tilt angle to the projector 100. The projector 100 corrects the installation angle determined by the design of the main body (a housing) based on the tilt angle (the tilt information) of the portable device 200 obtained from the portable device 200 to thereby calculate the tilt angle of the projector 100. Then, the projector 100 performs the keystone correction of the image corresponding to the tilt angle of the projector 100 thus calculated, and then projects the image on which the keystone correction has been performed on the screen SCR.

Thus, the projector 100 can adopt a configuration of omitting the tilt sensor, the camera, and so on, and it becomes possible to achieve downsizing and cost reduction of the projector 100. Moreover, it becomes possible to improve the accuracy of the keystone correction of the image due to the performance of the tilt detection sensor of the portable device 200 without being limited by various performances of the tilt detection sensor or the camera incorporated in the projector 100.

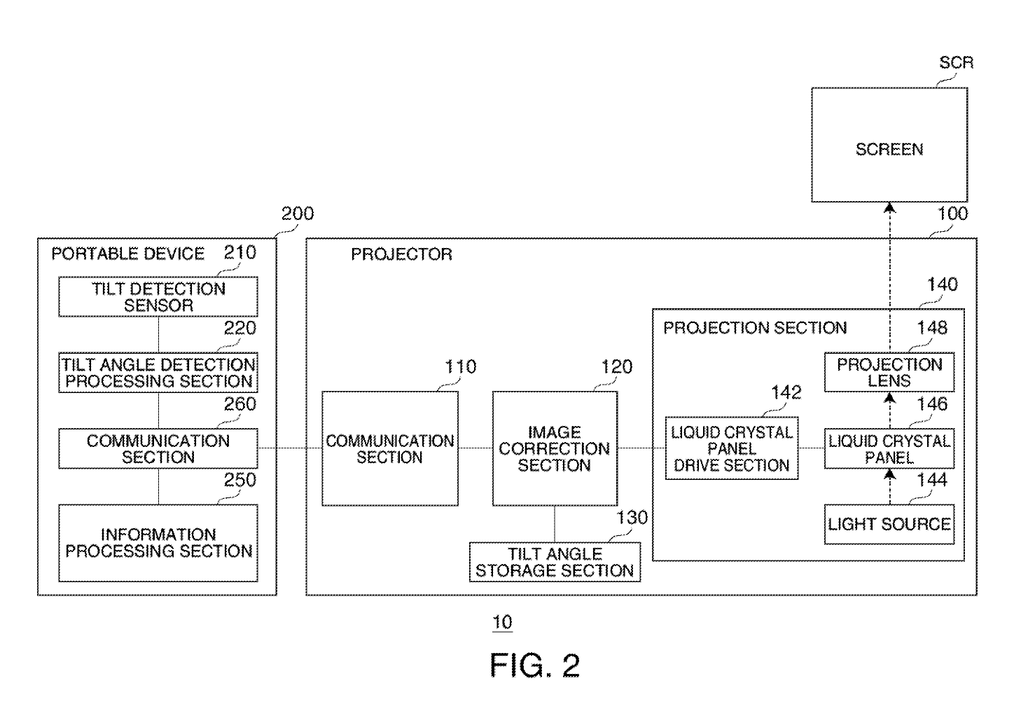

FIG. 2 shows a functional block diagram of a configuration example of the projector 100 and the portable device 200 constituting the projector system 10 according to the present embodiment. In FIG. 2, substantially the same constituents as in FIG. 1 are denoted with the same symbols.

The portable device 200 is provided with a tilt detection sensor 210, atilt detection processing section 220, an information processing section 250, and a communication section 260.

The tilt detection sensor 210 detects the tilt angle of the portable device 200. The tilt detection processing section 220 performs the process of converting the tilt angle detected by the tilt detection sensor 210 into a first tilt angle θ1 taking the horizontal plane as a base. The first tilt angle θ1 converted into in the tilt angle detection processing section 220 is output to the communication section 260.

The information processing section 250 includes a central processing unit (hereinafter referred to as CPU) and a memory, wherein the CPU reads out a program stored in the memory, and performs a process corresponding to the program to thereby perform predetermined information processing in the portable device 200. As the information processing performed by the information processing section 250, there can be cited audio signal processing, image generation processing, control of processing in each of the sections constituting the portable device 200, and so on.

The communication section 260 performs a transmission interface process and a reception interface process on the signal transmitted and received between the projector 100 and the portable device 200 when the projector 100 and the portable device 200 are connected to each other. The communication section 260 is capable of outputting the first tilt angle θ1 converted into in the tilt angle detection processing section 220 to the projector 100.

The projector 100 is provided with a communication section 110, an image correction section 120, a tilt angle storage section 130, and a projection section 140. The projection section 140 is provided with a liquid crystal panel drive section 142, a light source 144, a liquid crystal panel 146, and a projection lens 148.

The communication section 110 performs a transmission interface process and a reception interface process on the signal transmitted and received between the projector 100 and the portable device 200 when the projector 100 and the portable device 200 are connected to each other. The image correction section 120 performs the keystone correction of the image corresponding to the image data supplied from an image data supply device (e.g., a personal computer) not shown using the first tilt angle θ1 from the portable device 200. On this occasion, the image correction section 120 calculates the tilt angle θP of the projector 100 based on the first tilt angle θ1, and then performs the keystone correction of the image based on the tilt angle θP. Such an image correction section 120 includes, for example, a CPU and a memory, wherein the CPU reads out a program stored in the memory and performs a process corresponding to the program to thereby realize the keystone correction by software processing.

The tilt angle storage section 130 stores at least one of the tilt angle θP of the projector 100 calculated in the image correction section 120 and the first tilt angle θ1. For example, once the first tilt angle θ1 is stored, the projector 100 and the portable device 200 are no longer required to be connected to each other. Similarly, once the tilt angle θP of the projector 100 is stored, the projector 100 and the portable device 200 are no longer required to be connected to each other.

The projection section 140 projects the image corresponding to the image data, on which the keystone correction process has been performed in the image correction section 120, on the screen SCR based on the image data. Specifically, the liquid crystal panel drive section 142 drives the liquid crystal panel 146 based on the image data on which the keystone correction has been performed in the image control section 120. The liquid crystal panel 146 is irradiated with the light from the light source 144, and the liquid crystal panel 146 modulates the light from the light source 144. The projection lens 148 performs enlarged projection on the screen SCR using the light thus modulated by the liquid crystal panel 146.

Hereinafter, operation examples of the respective sections constituting the projector system 10 according to the present embodiment will be explained.

### Operation Example of Portable Device

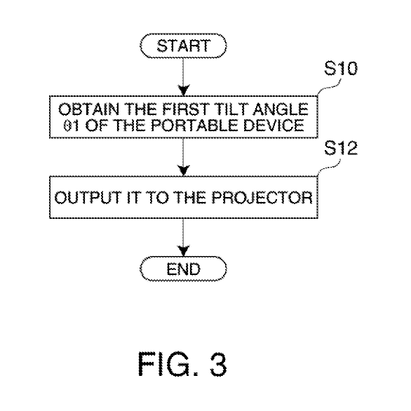

FIG. 3 shows a flowchart of a processing example of the portable device 200. The process shown in FIG. 3 is started when, for example, the portable device 200 detects the connection with the projector 100, or when receiving a predetermined tilt detection command from the projector 100.

Firstly, the tilt detection sensor 210 detects the tilt angle taking a predetermined reference surface of the portable device 200 as a base. Then, the tilt detection processing section 220 converts the tilt angle detected by the tilt detection sensor 210 into the first tilt angle θ1 taking the horizontal plane as a base to thereby obtain the tilt angle of the portable device 200 (step S10, the tilt angle detection step).

Then, the communication section 260 outputs (step S12) the first tilt angle θ1 to the projector 100, and then the series of processes is terminated (END).

### Operation Example of Projector

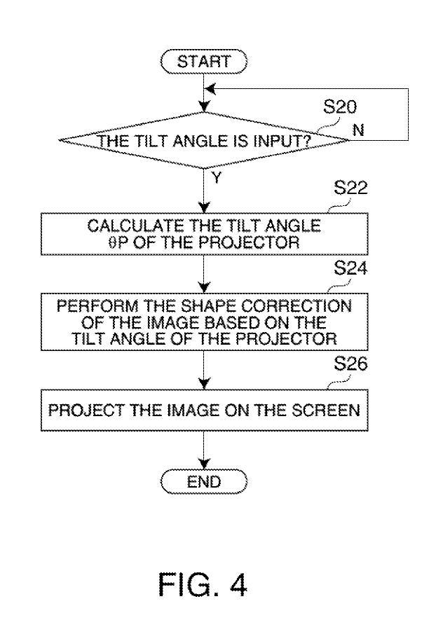

FIG. 4 shows a flowchart of an operation example of the projector 100. The process shown in FIG. 4 is started when detecting that, for example, the portable device 200 is connected to the projector 100.

Firstly, the communication section 110 determines (step S20) whether or not the first tilt angle θ1 detected in the portable device 200 has been input as a correction parameter of the keystone correction, and waits (N in the step S20) until the tilt angle is input. If the first tilt angle θ1 has been input (Y in the step S20), the image correction section 120 calculates (step S22) the tilt angle θP of the projector 100 using the first tilt angle θ1 having been input in the step S20. The tilt angle θP is stored in the tilt angle storage section 130.

Then, the image correction section 120 performs the keystone correction (step S24, the image correction step) based on the tilt angle θP of the projector 100 as the correction parameter. Then, the projection section 140 projects (step S26, the projection step) the image on which the keystone correction has been performed by the image correction section 120, and the series of processes is terminated (END).

It should be noted that it is preferable that every time the first tilt angle θ1 changes, the image correction section 120 performs the shape correction of the image using the tilt angle θP of the projector 100 and so on (the correction parameter in a broad sense), which has been calculated using the first tilt angle θ1 having changed.

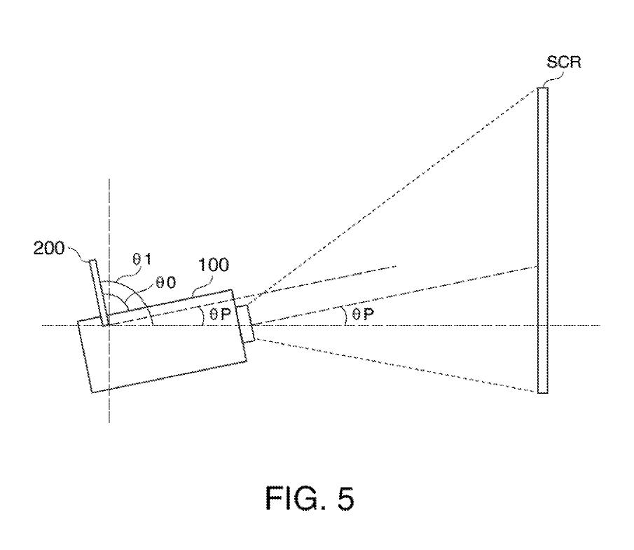

FIG. 5 shows an explanatory diagram of the tilt angle θP of the projector 100. FIG. 5 shows a side view of the projector 100 similarly to FIG. 1. It should be noted that in FIG. 5, substantially the same parts as those shown in FIG. 1 are denoted with the same reference symbols, and the explanation therefor will be omitted if appropriate.

As shown in FIG. 5, the tilt angle θP of the projector 100 is the angle formed between the horizontal plane and the projection light axis of the projector 100. The installation angle θ0 of the portable device 200 with respect to the projector 100 is the angle formed between the projector 100 and the portable device 200. Therefore, using the first tilt angle θ1 and the installation angle θ0, the tilt angle θP is calculated as the following formula in the step S22.

θP=θ1−θ0

The tilt angle θP of the projector 100 thus calculated as shown in FIG. 5 is stored in the tilt angle storage section 130. It should be noted that it is preferable that the first tilt angle θ1 is also stored in the tilt angle storage section 130 as well. Thus, once the first tilt angle θ1 and so on are obtained, the projector 100 and the portable device 200 are no longer required to be connected to each other.

As described above, in the present embodiment, the portable device 200 detects the first tilt angle θ1 of the portable device 200, and the projector 100 performs the shape correction of the image using the first tilt angle θ1 having been noticed from the portable device 200.

As is explained hereinabove, according to the present embodiment, it becomes possible to provide the projector 100 capable of performing the keystone correction without providing the special sensor such as the tilt detection sensor 210 and the special circuit such as the image analysis circuit. As a result, downsizing and cost reduction of the projector can be achieved.

Although the projector, the projector system, the image projection method, and so on according to the invention are explained hereinabove based on the embodiment described above, the invention is not limited to the embodiment described above. For example, the invention can be put into practice in various forms within the scope and spirit of the invention, and the following modifications, for example, are also possible.

1. Although in the embodiment described above the example in which the portable device is integrally connected to the projector at a predetermined installation angle to form a single body is explained, the invention is not limited thereto. If the angle formed between the projector and the portable device is known, the invention can also be applied to those connecting the projector and the portable device to each other with a cable instead of those integrally connecting the projector and the portable device to each other as a single body.

2. Although in the explanation of the embodiment described above it is assumed that the process of detecting the first tilt angle θ1 and so on is started upon detection of the connection between the portable device and the projector, or upon reception of the tilt detection command from the projector, the invention is not limited thereto. It is also possible for, for example, the projector to directly designate and start the application program installed in the portable device.

3. Although in the embodiment described above the example in which the projector performs the keystone correction is explained, the invention is not limited thereto. It is also possible to arrange that, for example, the projector performs a predetermined color correction or the like using the shot image obtained by shooting the projection surface with the imaging section provided to the portable device.

4. Although in the embodiment described above the liquid crystal projector is explained as an example of the projector, a display device such as a projector using a transmissive liquid crystal panel or a reflective liquid crystal panel can also be adopted. Further, the projector according to the invention can also be, for example, a projector using the digital micromirror device.

5. As the portable device in the embodiment described above, there can be cited a cellular phone, a smartphone, a personal data assistance (PDA), a portable music player, an electronic dictionary, an electronic notebook, a game machine, and a portable personal computer.

What is claimed is:

1. A projector used with an external device having a tilt detection function and configured so that the external device can be connected to a projector main body at a predetermined installation angle, the projector comprising:
an image correction section adapted to perform a shape correction of an image using a first tilt angle of the external device detected by the external device and the installation angle; and
a projection section adapted to project an image on which the shape correction has been performed by the image correction section.

2. The projector according to claim 1, wherein
the image correction section performs the shape correction of the image using a tilt angle of the projector obtained by correcting the first tilt angle with the installation angle.

3. The projector according to claim 2, further comprising:
a tilt angle storage section adapted to store the tilt angle of the projector.

4. The projector according to claim 1, wherein
every time the first tilt angle changes, the image correction section performs the shape correction of the image based on a correction parameter obtained using the first tilt angle having changed.

5. An image projection method of a projector used with an external device having a tilt detection function and configured so that the external device can be connected to a projector main body at a predetermined installation angle, the method comprising:
detecting a first tilt angle of the external device in a state of being connected to the projector main body;
performing a shape correction of an image using the first tilt angle detected in the detecting and the installation angle; and
projecting an image on which the shape correction has been performed.

6. The image projection method according to claim 5, wherein
the shape correction of the image is performed based on a tilt angle of the projector obtained by correcting the first tilt angle with the installation angle.

7. A projector comprising:
an interface adapted to hold an external device in a condition of being inserted;
a receiving section adapted to receive a first tilt angle of the external device from the external device via the interface;
a storage section adapted to store a tilt angle of the projector; and
a keystone correction section adapted to perform a keystone correction of the projector based on the first tilt angle received and the tilt angle stored.
